(19) United States
(12) Patent Application Publication
(10) Pub. No.: US 2012/0139806 A1
(43) Pub. Date: Jun. 7, 2012

(54) IFS BEAMFORMING ANTENNA FOR IEEE 802.11n MIMO APPLICATIONS

(76) Inventors: Ying Zhan, Beijing (CN); Bin Zhang, Beijing (CN); Bing Hou, Beijing (CN)

(21) Appl. No.: 13/307,856

(22) Filed: Nov. 30, 2011

Related U.S. Application Data
(60) Provisional application No. 61/419,113, filed on Dec. 2, 2010.

(51) Int. Cl. H01Q 13/10

(52) U.S. Cl. 343/770

(57) ABSTRACT

An antenna that is capable of accommodating both IEEE 802.11b/g traffic and IEEE 802.11n traffic is provided. The antenna includes a ground plane member, a plurality of inverted F slot antenna elements disposed at equidistant positions along a periphery of the ground plane member, and a plurality of slot elements disposed at equidistant positions along the periphery of the ground plane member is provided. First and second slot elements can be disposed on respective first and second sides of each inverted F slot antenna element, and each inverted F slot antenna element can operate in a first frequency band and in a second frequency band.

### CROSS-REFERENCE TO RELATED APPLICATIONS

This application claims priority to U.S. Provisional Patent Application No. 61/419,113 filed Dec. 2, 2010 and titled “IFS Beamforming Antenna for IEEE 801.11n MIMO Application.” U.S. Application No. 61/419,113 is hereby incorporated by reference.

### FIELD

The present invention relates generally to antennas. More particularly, the present invention relates to an IFS beamforming antenna for IEEE 802.11n MIMO applications.

### BACKGROUND

IEEE 802.11n-2009 is an amendment to the IEEE 802.11-2007 wireless network standard. IEEE 802.11n improves network throughput over two previous standards, IEEE 802.11a and 802.11g, in at least two ways. First, IEEE 802.11n operates with a 2.4 GHz/5 GHz duel frequency band. Second, IEEE 802.11n significantly increases the maximum raw data rate from 54 Mbit/sec to 600 Mbit/sec.

While many aspects of IEEE 802.11n are advantageous, IEEE 802.11n may be impractical for many users because there is a need to support legacy equipment that is compatible with only 802.11b/g. Therefore, until hardware that is compatible with 802.11n becomes more prevalent, it would be desirable to operate a mixed 802.11b/g/n network. In such a mixed-mode network, it would be desirable for a dual-radio access point to be employed such that 802.11b/g traffic is placed on a 2.4 GHz radio band and 802.11n traffic is placed on a 5 GHz radio band.

To implement the above-described mixed-mode network and dual-radio access point, there is a need for a 2.4 GHz/5 GHz dual frequency band multiple input and multiple output (MIMO) antenna. One known solution is to use several omni-directional external whip antennas for the 802.11n access point in a diversity scheme. This solution has been used for 2×2 and 3×3 MIMO applications. However, for MIMO applications with an increased number of inputs and outputs, the interference between the whip antennas is serious and the cosmetic appearance of the access point is unattractive.

Therefore, another known solution is to embed a single 2.4 GHz band antenna or a single 5 GHz band antenna inside of a radome. To operate in a dual frequency band, the two bands can be combined together with an RF switch. However, this solution doubles of the number of required antennas.

For example, in a 10×10 MIMO application, this solution requires the need to integrate ten antennas operating at 2.4 GHz and ten antennas operating at 5 GHz. This integration must occur in a small package size, which causes a large amount of interference. To minimize the interference, a diode, capacitive loading element, or an open stub can be added. However, these additional elements add cost to the access point and increase the production complexity.

In view of the above, an improved dual-radio access point that accommodates 802.11b/g traffic and 802.11n traffic is desired. Preferably, such an access point minimizes interference and the number of antennas employed while still being cosmetically attractive.

### SUMMARY

According to some embodiments, an antenna is provided. The antenna can include a ground plane member, a plurality of inverted F slot antenna elements disposed at equidistant positions along a periphery of the ground plane member, and a plurality of slot elements disposed at equidistant positions along the periphery of the ground plane member. First and second slot elements can be disposed on respective first and second sides of each inverted F slot antenna element, and each inverted F slot antenna element can operate in a first frequency band and in a second frequency band.

In some embodiments, each inverted F slot antenna element can include an aperture, and each inverted F slot antenna element aperture can include a first arm, a second arm, a shorting elbow, and a notch. The first arm can be substantially parallel to the second arm, the shorting elbow can be substantially perpendicular to the first arm and the second arm, and the shorting elbow can connect the first arm to the second arm by being integrally contiguous with the first arm and the second arm. A length of the first arm can be longer than a length of the second arm, and the notch can be disposed along the length of the first arm.

The antenna according to disclosed embodiments can be capable of accommodating IEEE 802.11b/g traffic as well as IEEE 802.11n traffic. In some embodiments, the antenna can operate in both a 2.4 GHz frequency band and in a 5 GHz frequency band. The plurality of slot elements can be capable of substantially reducing or eliminating interference between each of the inverted F slot antenna elements. Accordingly, high isolation can be achieved.

A MIMO beamforming antenna is also provided. The MIMO beamforming antenna can include a plurality of inverted F slot antenna elements such that each element can radiate in a 2.4 GHz frequency band and in a 5 GHz frequency band.

According to some embodiments, an IEEE 802.11n access point is also provided. The IEEE 802.11n access point can include a MIMO antenna, which can include a plurality of inverted F slot antenna elements such that each element can radiate in a 2.4 GHz frequency band and in a 5 GHz frequency band.

### BRIEF DESCRIPTION OF THE DRAWINGS

FIG. 1 is a schematic view of a MIMO antenna;

FIG. 1A is an enlarged view of an exemplary IFS antenna element of the MIMO antenna of FIG. 1; and

FIG. 2 is a schematic view of the MIMO antenna of FIG. 1 showing the dimensions of one IFS antenna element thereof.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Various embodiments are described that include an improved dual-radio access point that accommodates 802.11b/g traffic and 802.11n traffic. In accordance with some embodiments, such an access point minimizes interference and the number of antennas employed while still being cosmetically attractive.

For example, an access point in accordance with some embodiments can include a 2.4 GHz/5 GHz dual frequency band multiple input and multiple output (MIMO) antenna with a plurality of inverted F slot (IFS) beamforming antennas. Each IFS antenna element can radiate in the 2.4 GHz frequency band and in the 5.0 GHz frequency band. In some embodiments, each antenna element can radiate as a directional antenna in a horizontal direction.

The MIMO antenna shown and described herein can be manufactured by a piece of stamping sheet metal or printed circuit board (PCB) material. Therefore, the MIMO antenna in accordance with disclosed embodiments can be manufactured in a more cost effective manner as compared to PCB antennas and other three-dimensional forming antennas.

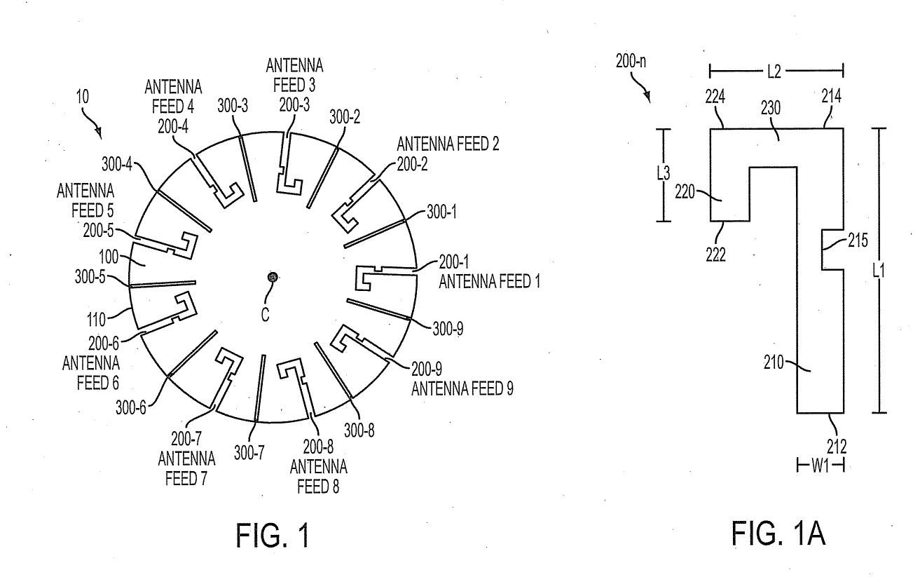

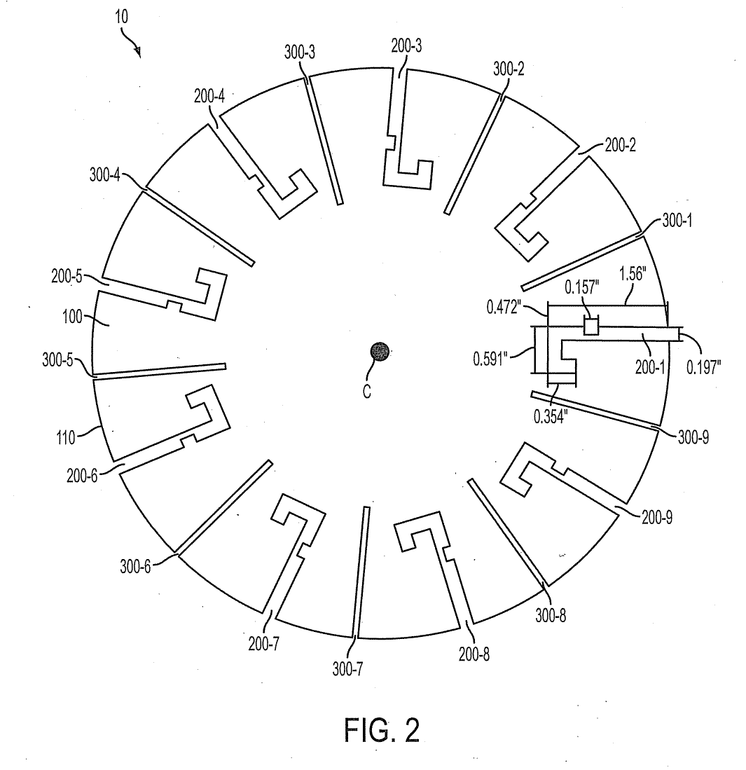

FIG. 1 and FIG. 2 are schematic views of an exemplary MIMO antenna 10. FIG. 2 shows the dimensions of one IFS antenna element in the MIMO antenna 10. However, it is to be understood that the dimensions shown in FIG. 2 are only exemplary and could vary as would be known by those of skill in the art.

The MIMO antenna 10 shown in FIG. 1 and FIG. 2 is a 9×9 application including nine IFS antenna elements and nine slot elements. However, it is to be understood that a MIMO antenna in accordance with embodiments disclosed herein is not so limited. FIG. 1 and FIG. 2 are merely exemplary, and the MIMO antenna can include any number of IFS beamforming antennas and slot elements. For example, a MIMO antenna in accordance with disclosed embodiments could be a 4×4 antenna, a 12×12 antenna, or any other size antenna as would be known and desired by those of skill in the art.

As seen in FIG. 1, a MIMO antenna 10 in accordance with some embodiments can include a unitary ground plane member 100 that can be, for example, circular, ovular, oblong, rectangular, or any other shape as would be known and desired by those of skills in the art. The member 100 shown in FIG. 1 is circular, but embodiments disclosed herein are not so limited.

A plurality of IFS antenna elements 200-1, 200-2, 200-3, 200-4, 200-5, 200-6, 200-7, 200-8, 200-9 and a plurality of slot elements 300-1, 300-2, 300-3, 300-4, 300-5, 300-6, 300-7, 300-8, 300-9 can be disposed in and/or on the ground plane member 100 in a co-planar manner. For example, as seen in FIG. 1, the plurality of IFS antenna elements 200-1, 200-2, 200-3, 200-4, 200-5, 200-6, 200-7, 200-8, 200-9 can be disposed in an equidistant manner along a periphery 110 of the ground plane member 100. The plurality of slot elements 300-1, 300-2, 300-3, 300-4, 300-5, 300-6, 300-7, 300-8, 300-9 can also be disposed in an equidistant manner along the periphery 100 of the member 100.

In some embodiments, the IFS antenna elements 200-1, 200-2, 200-3, 200-4, 200-5, 200-6, 200-7, 200-8, 200-9 and the slot elements 300-1, 300-2, 300-3, 300-4, 300-5, 300-6, 300-7, 300-8, 300-9 can alternate. Thus, a first slot element, for example, 300-1, can be disposed on a first side of an IFS antenna element, for example, 200-1, and a second slot element, for example, 300-9, can be disposed on a second side of the IFS antenna element 200-1. Each IFS antenna element 200-n can a slot element 300-n on first and second sides thereof.

The number of IFS antenna elements 200-1, 200-2, 200-3, 200-4, 200-5, 200-6, 200-7, 200-8, 200-9 can be equal to the number slot elements 300-1, 300-2, 300-3, 300-4, 300-5, 300-6, 300-7, 300-8, 300-9. For example, the MIMO antenna 10 shown in FIG. 1 includes nine IFS antenna elements and nine slot elements.

As seen in FIG. 1A, Each IFS antenna element 200-n can include a cut-out or aperture disposed in the ground plane member 100. The aperture can include a first arm 210, a second arm 220, and a shorting elbow 230. The first arm 210, the second arm 220, and the shorting elbow 230 can be contiguous with one another to form one single, contiguous cut-out or aperture.

For each IFS antenna element 200-n, the first arm 210 can extend from the periphery 110 of the ground plane member 100 towards the center C of the member 100. Thus, a first end 212 of the first arm 210 can be at the periphery 110 of the ground plane member 100, and a second end 214 of the first arm 210 can be at a position on the ground plane member 100 away from the periphery 110.

The first arm 210 can have a length L1 and include a notch 215 along the length L1 thereof. For example, the notch 215 can include a portion of the ground plane member 100 protruding into the cut-out or aperture of the first arm 210. In some embodiments, the notch 215 can be at an approximately half-way point along the length L1 of the first arm 210.

In some embodiments, the length L1 of the first arm 210 can be between approximately 1.5 and 1.6 inches, for example, as seen in FIG. 2, approximately 1.56 inches. In some embodiments, the length of the notch 215 can be between approximately 0.1 and 0.2 inches, for example, as seen in FIG. 2, approximately 0.157 inches. Thus, in some embodiments, the length of the notch 215 can be approximately 10% of the length of the length L1 of the first arm 210.

In some embodiments, the width W1 of the first arm 210 can be between approximately 0.1 and 0.2 inches, for example, as seen in FIG. 2, approximately 0.197 inches.

The shorting elbow 230 can be substantially perpendicular to the first arm 210 and be integrally contiguous with a second end 214 of the first arm 210. The shorting elbow 230 can also be substantially perpendicular with the second arm 220 and be integrally contiguous with a second end 224 of the second arm 220. Thus, the shorting elbow 230 can connect the first arm 210 and the second arm 220.

The shorting elbow 230 can have a length L2. In some embodiments, the length L2 of the shorting elbow 230 can be between approximately 0.5 and 0.6 inches, for example, as seen in FIG. 2, approximately 0.591 inches.

In some embodiments, the notch 215 can have width. A first portion of the width of the notch 215 can extend into the aperture of the IFS antenna element 200-n, and a second portion of the width of the notch 215 can extend into or onto the ground plane member 100, outside of the aperture. In some embodiments, the length L2 of the shorting elbow 230 plus the width of the second portion of the notch 215 can be between approximately 0.4 and 0.5 inches, for example, as seen in FIG. 2, approximately 0.472 inches.

The second arm 220 can be substantially parallel to the first arm 210. Additionally, the second arm 220 can have a length L3, and in some embodiments, the length L3 of the second arm 220 can be smaller than the length L1 of the first arm 210. For example, in some embodiments, the length L3 of the second arm 220 can be between approximately 0.3 and 0.4 inches, for example, as seen in FIG. 2, approximately 0.354 inches. Thus, in some embodiments, the length L3 can be between approximately 20% and 25% of the length L1. In still further embodiments, the length L3 can be approximately 22% of the length L1.

A first end 222 of the second arm 224 can be at a position on the ground plane member 100 away from the periphery 110, and a second end 224 of the second arm 220 can also be at a position on the ground plane member 100 away from the periphery 110. The first end 222 of the second arm 220 can be closer to the periphery 110 than the second end 224 of the second arm 220. That is, the second end 224 of the second arm can be closer to the center C of the ground plane member 100 than the first end 222 of the second arm 220.

Each slot element 300-n can include a cut-out or aperture disposed in the ground plane member 100. The aperture can be linear and have a length L4. In some embodiments the length L4 of a slot element 300-n can be longer than the length L1 of the first arm 210 of an IFS antenna element 200-n.

In some embodiments, the slot elements 300-1, 300-2, 300-3, 300-4, 300-5, 300-6, 300-7, 300-8, 300-9 disposed between the IFS antenna elements 200-1, 200-2, 200-3, 200-4, 200-5, 200-6, 200-7, 200-8, 200-9 can improve the radiation pattern of the IFS antenna elements 200-1, 200-2, 200-3, 200-4, 200-5, 200-6, 200-7, 200-8, 200-9. In some embodiments, the slot elements 300-1, 300-2, 300-3, 300-4, 300-5, 300-6, 300-7, 300-8, 300-9 disposed between the IFS antenna elements 200-1, 200-2, 200-3, 200-4, 200-5, 200-6, 200-7, 200-8, 200-9 can also improve the isolation between the IFS antenna elements 200-1, 200-2, 200-3, 200-4, 200-5, 200-6, 200-7, 200-8, 200-9. For example, in some embodiments, the slot elements 300-1, 300-2, 300-3, 300-4, 300-5, 300-6, 300-7, 300-8, 300-9 can substantially reduce, minimize, or eliminate interference between the IFS antenna elements 200-1, 200-2, 200-3, 200-4, 200-5, 200-6, 200-7, 200-8, 200-9.

From the foregoing, it will be observed that numerous variations and modifications may be effected without departing from the spirit and scope of the invention. It is to be understood that no limitation with respect to the specific system or method illustrated herein is intended to should be inferred. It is, of course, intended to cover by the appended claims all such modifications as fall within the spirit and scope of the claims.

What is claimed is:

1. An antenna comprising:
a ground plane member;
a plurality of inverted F slot antenna elements disposed at equidistant positions along a periphery of the ground plane member; and
a plurality of slot elements disposed at equidistant positions along the periphery of the ground plane member,
wherein first and second slot elements are disposed on respective first and second sides of each inverted F slot antenna element, and
wherein each inverted F slot antenna element operates in a first frequency band and in a second frequency band.

2. The antenna of claim 1, wherein the ground plane member is one of circular, ovular, oblong, and rectangular.

3. The antenna of claim 1, wherein the ground plane member includes at least one of a piece of sheet metal and a printed circuit board material.

4. The antenna of claim 1, wherein the number of inverted F slot antenna elements equals the number of slot elements.

5. The antenna of claim 1, wherein each of the plurality of inverted F slot antenna elements includes an aperture.

6. The antenna of claim 5,
wherein each inverted F slot antenna element aperture includes a first arm, a second arm, a shorting elbow, and a notch,
wherein the first arm is substantially parallel to the second arm,
wherein the shorting elbow is substantially perpendicular to the first arm and the second arm,
wherein the shorting elbow connects the first arm to the second arm by being integrally contiguous with the first arm and the second arm,
wherein a length of the first arm is longer than a length of the second arm, and
wherein the notch is disposed along the length of the first arm.

7. The antenna of 6, wherein the notch includes a portion of the ground plane member protruding into the aperture.

8. The antenna of claim 1, wherein each of the plurality of slot elements includes an aperture.

9. The antenna of claim 8, wherein each slot element aperture includes a linear aperture.

10. The antenna of claim 1, wherein the antenna is capable of accommodating IEEE 802.11b/g traffic and IEEE 802.11n traffic.

11. The antenna of claim 1, wherein the plurality of slot elements is capable of substantially eliminating interference between each of the plurality of inverted F slot antenna elements.

12. The antenna of claim 1, wherein the first frequency band includes a 2.4 GHz frequency band.

13. The antenna of claim 1, wherein the second frequency band includes a 5 GHz frequency band.

14. The antenna of claim 1, wherein each of the plurality of inverted F slot antenna elements operates as a directional antenna.

15. The antenna of claim 1, wherein the plurality of inverted F slot antenna elements includes four, nine, or twelve inverted F slot antenna elements.

16. The antenna of claim 1, wherein the plurality of slot elements includes four, nine, or twelve slot elements.

17. A MIMO beamforming antenna comprising a plurality of inverted F slot antenna elements, each element radiating in a 2.4 GHz frequency band and in a 5 GHz frequency band.

18. The MIMO beamforming antenna of claim 17 further comprising a slot element disposed on first and second sides of each inverted F slot antenna element.

19. An IEEE 802.11n access point comprising a MIMO antenna, wherein the MIMO beamforming antenna includes a plurality of inverted F slot antenna elements, each element radiating in a 2.4 GHz frequency band and in a 5 GHz frequency band.

20. The IEEE 802.11n access point of claim 19, wherein the MIMO beamforming antenna includes a slot element disposed on first and second sides of each inverted F slot antenna element.
